(19) United States
(12) Patent Application Publication
(10) Pub. No.: US 2016/0341588 A1
(43) Pub. Date: Nov. 24, 2016

(54) METERING MACHINE

(71) Applicant: TREMARK TECHNOLOGIES INC., Montreal (CA)

(72) Inventor: Jean-Charles MARCHADOUR, Pont L'Abbe (FR)

(73) Assignee: TREMARK TECHNOLOGIES INC., Montreal (CA)

(21) Appl. No.: 15/159,911

(22) Filed: May 20, 2016

(30) Foreign Application Priority Data
May 22, 2015 (FR) 15 54640

(51) Int. Cl. G01F 3/24; B65G 11/20; F16M 1/00

(52) U.S. Cl. CPC G01F 3/24; F16M 1/00; B65G 11/206

(57) ABSTRACT

Metering machine (1) including a frame (2) on which are mounted a feed hopper (3) and a metering sleeve (5) mounted between an outlet (6) of the feed hopper (3) and a discharge pipe (72), characterized in that the metering sleeve (5) includes a radial window (12) and is rotatable about a longitudinal axis (X) by rotation drive means (40, 41) adapted to position the metering sleeve (5) selectively in a first position in which the radial window (12) faces the outlet (6) of the feed hopper (3) and a second position in which the radial window (12) faces a feed end of the discharge pipe (72).

### FIELD OF THE INVENTION

The present invention concerns the metering of products such as food products.

### BACKGROUND OF THE INVENTION

A metering machine generally includes a frame to which are fixed:
a feed hopper;
a metering unit including a metering sleeve that is connected to an outlet of the hopper and receives a sliding piston;
means for driving the piston;
a pipe for discharging the product connected to the metering sleeve;
a three-way plug valve for selectively connecting the interior of the metering sleeve with the feed hopper or the discharge pipe.

When the machine must be cleaned, for example because the product to be metered is changed, it is necessary to demount manually the distribution pipe, the metering unit and the plug valve in order to be able to introduce a cleaning product into the interior thereof. This demounting, and the subsequent remounting, must be carried out by qualified workers because correct operation of the machine depends on carrying them out correctly.

For machines including a plurality of metering units mounted on a turntable, it is necessary to remove each of the elements of the metering units individually and to hold the turntable very accurately in position relative to the metering units in order to reduce the times taken to remount the elements on the turntable and to adjust said turntable.

To simplify the demounting and remounting operations, it is known, notably from the document FR-A-2843798, to mount a metering unit on a support element articulated to the frame. This arrangement facilitates the relative positioning of the parts to be remounted during remounting. The demounting and remounting operations are still essentially manual operations, however, carried out by personnel trained to this end and that require prolonged immobilization of the metering machine.

### OBJECT OF THE INVENTION

One aim of the invention is to simplify the operations of cleaning a metering machine and also to reduce the time for which the machine is immobilized when cleaning it.

### SUMMARY OF THE INVENTION

To this end, there is provided a metering machine including a frame on which are mounted a feed hopper and a metering sleeve mounted between an outlet of the feed hopper and a discharge pipe. The metering sleeve receives slidably along a longitudinal axis a suction and discharge piston, the metering machine including means for driving the piston. In accordance with the invention, the metering sleeve includes a radial window and is rotatable about the longitudinal axis by rotation drive means to position the sleeve selectively in a first position in which the radial window faces the outlet of the feed hopper and a second position in which the radial window faces a feed end of the discharge pipe.

Such a machine limits the number of parts and simplifies their respective connections because the sleeve performs the function of the three-way plug valve. Accordingly, during cleaning operations, there are fewer parts and they are easier to remove and refit.

The piston is advantageously mounted on the frame to slide between a working first position in which the piston is in the metering sleeve and a cleaning position in which the piston is disengaged from the metering sleeve.

Thus the demounting and the remounting of the metering unit (the assembly comprising the metering sleeve and the piston) are automated. The demounting and remounting operations are therefore simple and can be carried out by unskilled personnel. Automation moreover makes it possible to render these operations fast and reliable.

In accordance with one particularly advantageous embodiment, the metering sleeve includes an abutment disposed so that the piston comes into contact therewith when it goes to the cleaning position. This makes it possible, by a single movement in translation of the piston, to bring about disengagement of the metering sleeve at the same time as disengagement of the piston.

Other features and advantages of the invention will emerge on reading the following description of nonlimiting embodiments of the invention.

### BRIEF DESCRIPTION OF THE DRAWINGS

Reference will be made to the appended drawings, in which:

FIG. 1 is a view in longitudinal section of a metering machine in accordance with the invention in a phase before metering;

FIG. 2 is a view in longitudinal section of a metering machine in accordance with the invention during a first metering phase;

FIG. 3 is a view in longitudinal section of a metering machine in accordance with the invention during a second metering phase;

FIG. 4 is a perspective view of the metering machine from FIG. 1;

FIG. 5 is a view of the metering machine from FIG. 1 in section taken along the line V-V;

FIG. 6 is a view of the metering machine from FIG. 2 in section taken along the line VI-VI;

FIG. 7 is a view identical to FIG. 1 of the metering machine in a third metering phase;

FIG. 8 is a view identical to FIG. 1 of the metering machine in a first demounting phase;

FIG. 9 is a view identical to FIG. 1 of the metering machine in a second demounting phase;

FIG. 10 is a perspective view of the metering machine from FIG. 9;

FIG. 11 is a view identical to FIG. 1 of the metering machine in a third demounting phase.

### DETAILED DESCRIPTION OF THE INVENTION

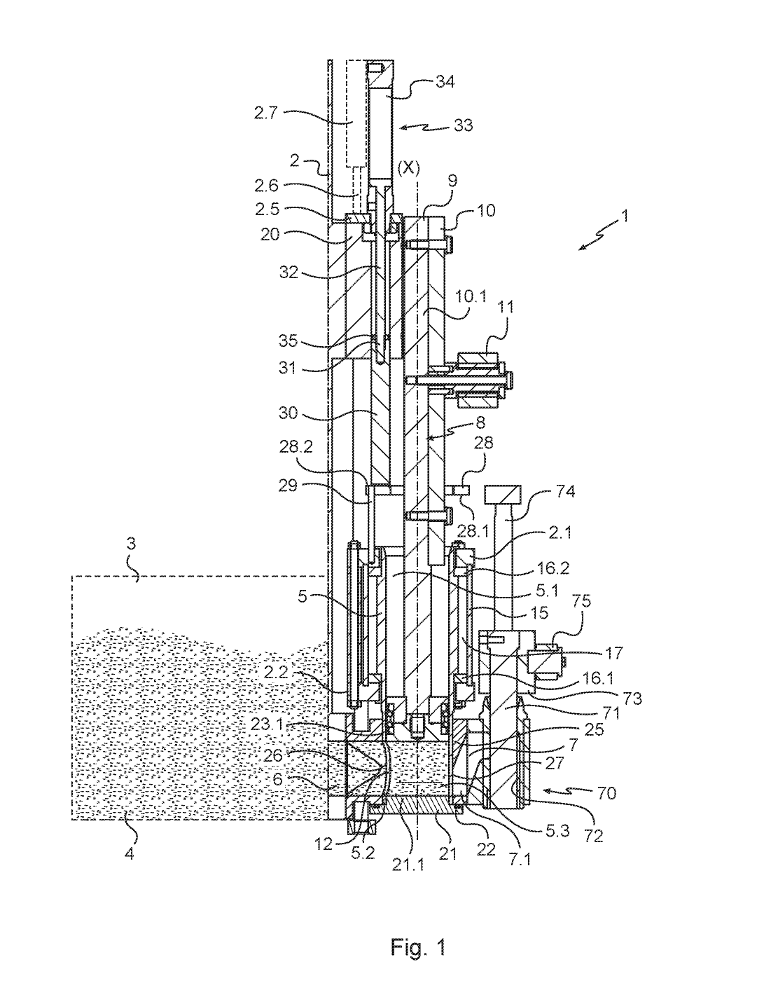

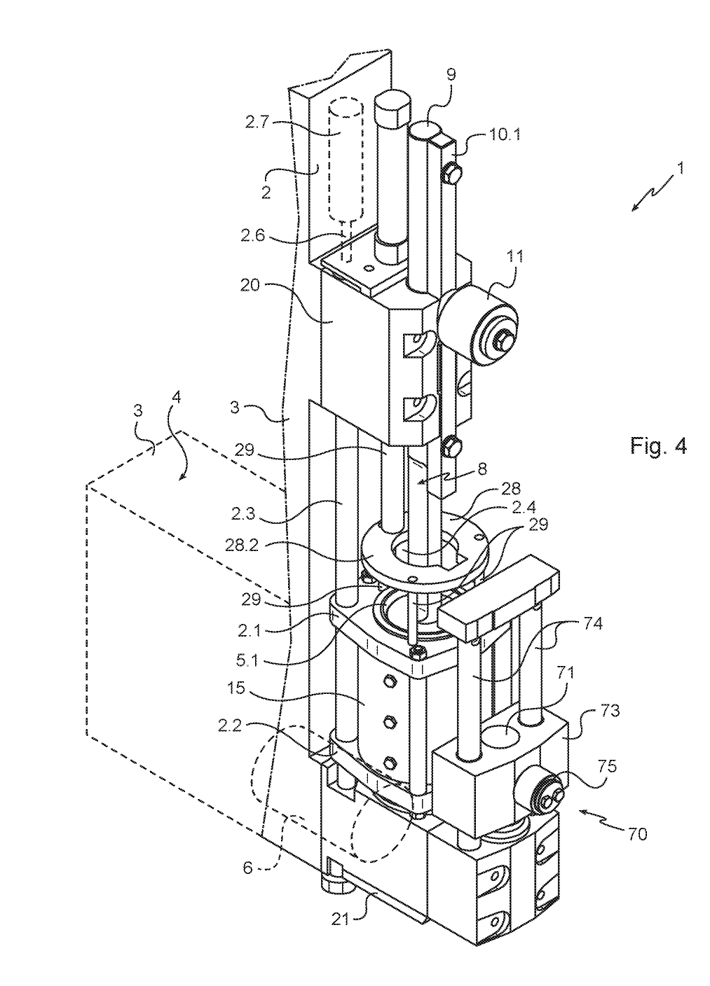

Referring to FIGS. 1 to 6, the metering machine in accordance with the invention, generally designated 1, includes a frame 2 on which are mounted a feed hopper 3 for the product to be packaged—here a foodstuff paste 4—and a metering sleeve 5 mounted between an outlet 6 of the hopper 3 and a discharge pipe 72. A plunger 71 slides in the discharge pipe 72, the lower end of which dispenses the foodstuff paste 4 into a container to be filled (not shown). The plunger 71 is fastened to a block 73 sliding of which is guided by two columns 74 and which is provided with a roller 75 cooperating with a cam in the form of a rail (not shown) moving relative to the roller 75. A metering siphon 7 is disposed between the metering sleeve 5 and the discharge pipe 72. The metering sleeve 5 is of cylindrical shape and extends along a longitudinal axis X. The metering sleeve 5 has an open upper end 5.1 through which extends a suction and discharge piston 8 that is received so as to slide along the longitudinal axis X. The piston rod 9 of the piston 8 receives a screwed-on guide rod 10 from which projects a roller 11 cooperating with a cam in the form of a rail (not shown) moving relative to the roller 11. The frame 2 includes a support 20 two walls of which come into contact with the flanks 10.1 of the guide rod 10, thus guiding movement in translation of the piston 8 relative to the metering sleeve 5.

A lower portion 5.2 of the metering sleeve 5 is slidably and rotatably engaged in a bore 23.1 of a cylindrical plug 23 with axis X fastened to the frame 2. The metering sleeve 5 has an open lower end 5.3 that comes to abut against a disk 21 from which projects a cylindrical portion 21.1 engaged in the lower end 5.3. The disk 21 includes a flat annular seal 22. The disk 21 closes the lower portion of the cylindrical plug 23. Thus the portion 21.1 guides rotation of the metering sleeve 5 around the axis X.

The disk 21 is fastened to the lower end of two parallel columns 2.3 and 2.4. These columns 2.3 and 2.4 are mounted to slide relative to the frame 2 at the level of the support 20 and their respective upper ends are fastened to a plate 2.5 connected to the piston rod 2.6 of a pneumatic cylinder 2.7. Finally, the wall 25 of the bore 23.1 in the plug 23 includes two radial windows 26 and 27 disposed at 180° to each other. The radial windows 26 and 27 respectively open onto the outlet 6 of the hopper 3 and onto a first end 7.1 of the metering siphon 7. The radial windows 26 and 27 are of substantially rectangular section and include a base of the same length. Here, the height h₂₆ of the radial window 26 is greater than the height h₂₇ of the radial window 27.

The metering sleeve 5 includes a radial window 12, also rectangular and substantially the same height as the window 26 and is rotatable about the axis X. The metering sleeve 5 can therefore selectively adopt a first position in which the radial window 12 faces the radial window 26—and therefore in which the interior of the metering sleeve 5 is connected to the outlet of the hopper 3—and a second position in which the radial window 12 faces the radial window 27 and thus connects the interior of the metering sleeve 5 and the metering siphon 7 that feeds the discharge pipe 72.

The metering sleeve 5 also includes a rod 13 of square section with a first portion of its section extending parallel to the axis X in a groove 14 of the metering sleeve 5. A cylindrical tube portion 15 extends around the metering sleeve 5 and is received between two annular seals 16.1 and 16.2. The tube portion 15 and the seals 16.1 and 16.2 are retained in an upper flange 2.1 and a lower flange 2.2 slidably mounted on the columns 2.3 and 2.4. The flange 2.2 also includes a flat annular seal 23.2 that comes to bear on the upper portion of the plug 23. The seals 16.1 and 16.2 and the tube portion 15 delimit a sealed chamber 17 fastened to the frame 2. Two rods 18 and 19 of square section and at an angle substantially greater than 180° to each other are screwed onto the tube section 15 and extend into the chamber 17 until they come into sealed contact with the exterior wall of the metering sleeve 5. The second portion of the section of the rod 13 projects from the metering sleeve 5 and defines a wall 36 that with the rods 18 and 19 delimits two sealed volumes 40 and 41 in the chamber 17. The first sealed volume 40 is delimited by the rod 18, the seals 16.1 and 16.2, the exterior face of the metering sleeve 5, the interior face of the cylinder portion 15 and the wall 36. The second sealed volume 41 is delimited by the rod 19, the seals 16.1 and 16.2, the exterior face of the metering sleeve 5, the interior face of the cylinder portion 15 and the wall 36. At the level of each rod 18 and 19 the tube portion 15 receives a compressed air injection nozzle 18.1 and 19.1 controlled by a system 60 of cams that is not shown. The position of the rods 18 and 19 is such that the rod 13 rotates approximately 180° when it goes from a position in which it is abutted against the rod 18 to a position in which it abutted against the rod 19.

The metering sleeve 5 also includes an annular abutment 28 the lower surface 28.1 of which is connected to the flange 2.1 by three legs 29. The abutment 28 includes a circular bore with axis X and extends at a distance from the upper first end 5.1 of the metering sleeve 5. A rod 30 screwed to the end 31 of a piston 32 extends from the support 20 to the upper surface 28.2 of the abutment 28. A linear pneumatic actuator, here a cylinder 33, includes a sleeve 34 that projects from and is screwed to the upper face of the support 20. The end 31 of the piston 32 is threaded and receives a counter-nut 35 against which the rod 30 bears. The positions of the counter-nut 35 and the rod 30 then make it possible to adjust the force applied by the cylinder 33 to the abutment 28.

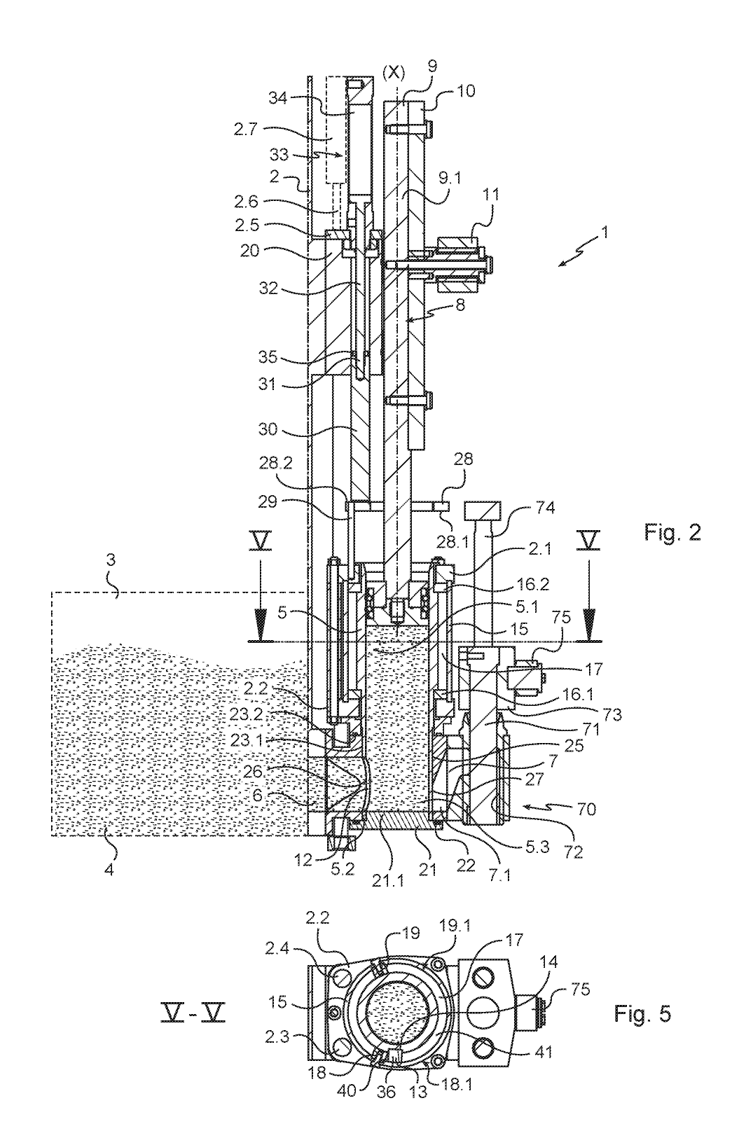

In the context of the present application, and as is usual in the field of metering machines, a piston is at its low point when the volume of the chamber that it defines with the cylinder is the smallest. Similarly, a piston is at its high point when the volume of the chamber that it defines with the cylinder is the largest. Accordingly, in the FIG. 1 representation, the piston 8 is at its low point. In the FIG. 2 representation, the piston 8 is at its high point.

In operation, and in a step preceding metering, the piston 8 is moved to its low point, which allows the air contained in the cylinder to escape to the hopper 3 (FIG. 1).

In a first metering step, the metering machine 1 is in the initial configuration corresponding to FIG. 1 in which:
the piston 8 is at its low point in which the head of the piston 8 is flush with the upper edge of the radial window 12;
the wall 36 is abutted against the rod 18, the first sealed volume 40 has its minimum volume and the second sealed volume 41 has its maximum volume;
the metering sleeve 5 is then in its first position in which the radial window 12 faces the radial window 26 of the plug 23, thus establishing communication between the interior of the metering sleeve 5 and the outlet 6 of the hopper 3;
the plunger 71 is at its low point;
the piston 32 of the cylinder 33 is deployed and the rod 30 comes into contact with the abutment 28 to block movement in translation of the metering sleeve 5 along the axis X (the force applied by the rod 30 also makes it possible to compress the seal 21 between the radial wall 5.3 and the bottom 22 of the plug 23).

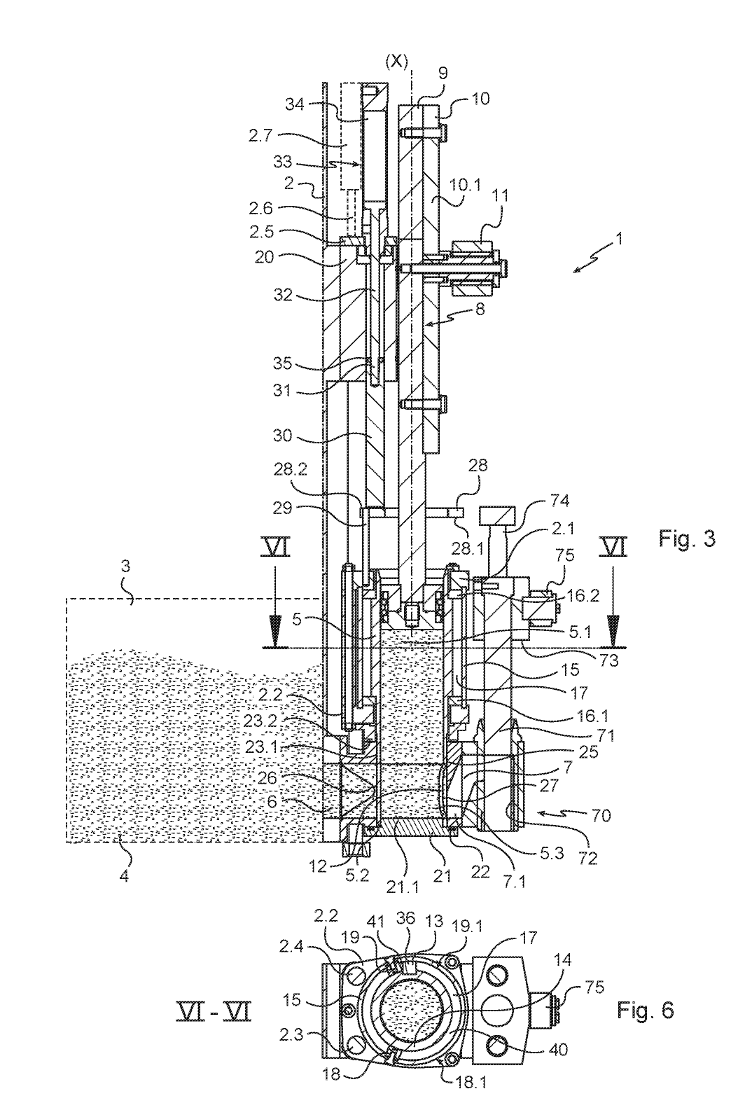

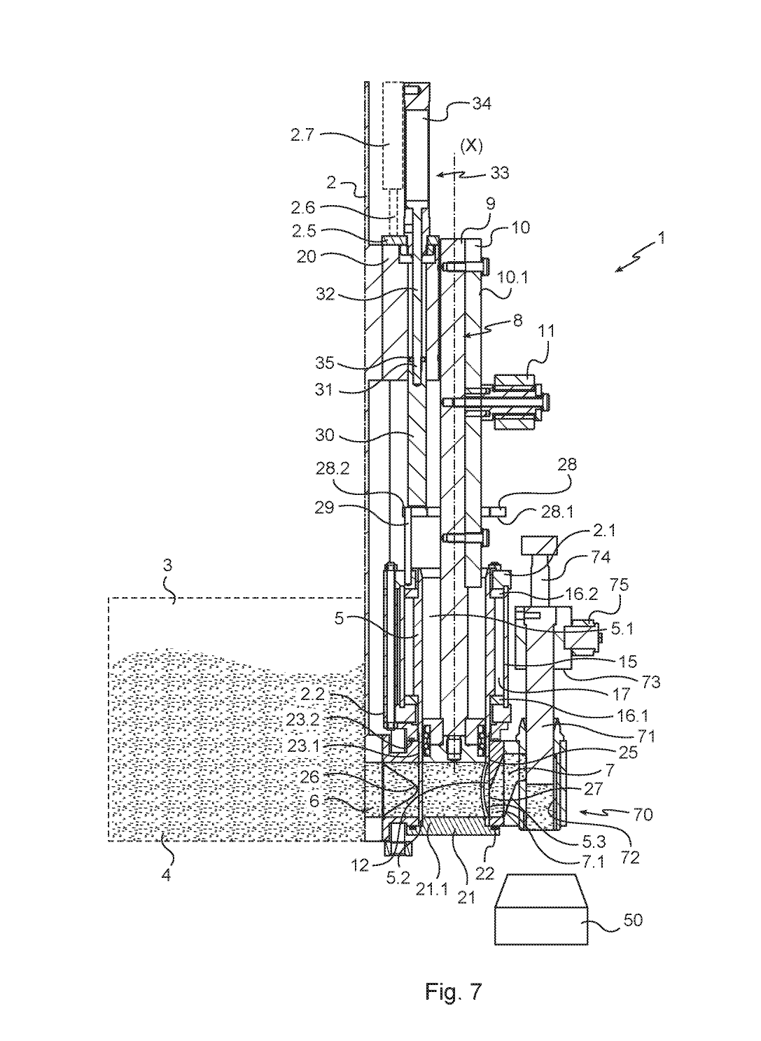

In this position, the piston 8 has sucked in metered volume the foodstuff paste 4 corresponding to the product of the stroke of the piston 8 and the inside diameter of the metering sleeve 5 (FIG. 2). During the second metering step, the cam system 60 commands the feeding of air to the compressed air injection nozzle 18.1 which then introduces compressed air into the first sealed volume 40. This causes the metering sleeve 5 to rotate from its first position to its second position, represented in FIG. 3. In that position, the wall 36 is abutted against the rod 19, the second volume 41 has its minimum volume and the first sealed volume 40 has its maximum volume. In a third metering step, the guide rail of the roller cam 75 commands sliding of the plunger 71 to its high point. When the plunger 71 is at its high point, the guide rail of the roller cam 11 commands the sliding of the piston 8 to its low point. During this movement, the foodstuff paste 4 contained in the metering sleeve 5 is transferred from the interior of the metering sleeve 5 to the discharge pipe 72 via the metering siphon 7. Just before the piston 8 reaches its low point, the plunger 71 slides to block the window 7.2. The foodstuff paste 4 present in the siphon 7 therefore remains under pressure and the plunger 71 provides sealed isolation of the siphon 7 and the discharge pipe 72. This makes it possible to prevent the product situated in the upper volume of the siphon 7 from being able to flow in the discharge pipe 72 by gravity and falsify the metering. This is particularly true for products containing a high liquid phase such as jams. This situation is represented in FIG. 7. In a fourth metering step, the guide rail cooperating with the roller 75 commands the movement of the plunger 71 to its low point, which causes the food paste 4 to be transferred from the discharge pipe 72 to the interior of the container to be filled. In a fifth metering step, the cam system 60 commands the feeding of air to the compressed air injection nozzle 19.1 which then introduces compressed air into the second sealed volume 41. This then causes the metering sleeve 5 to rotate from its second position to its first position and the metering cycle can begin again from the first step.

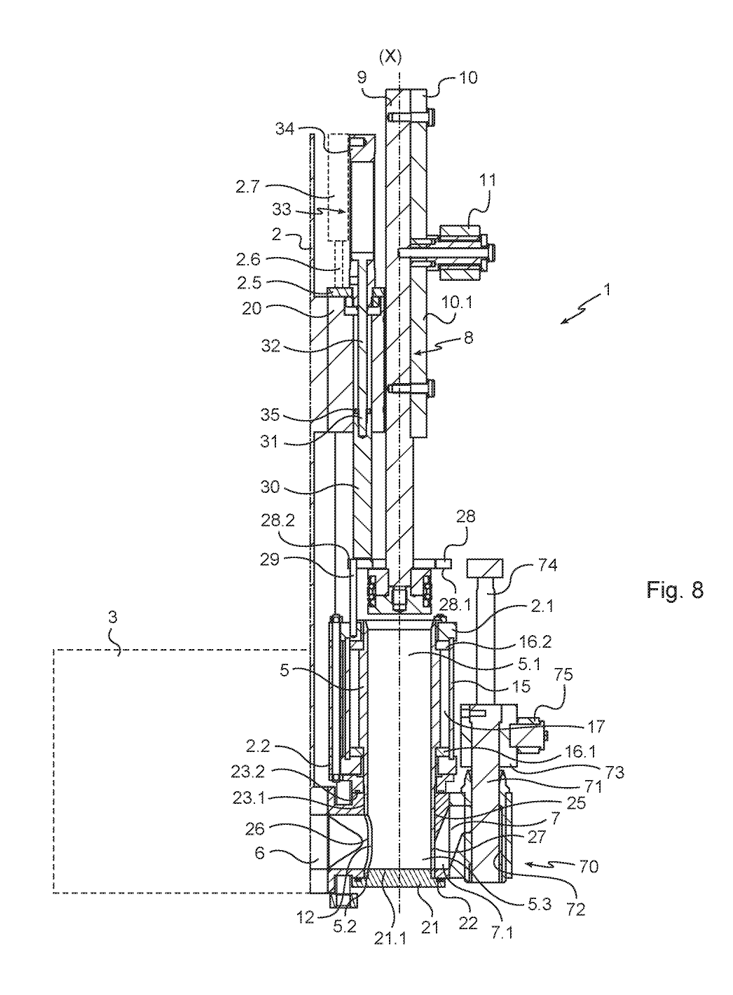

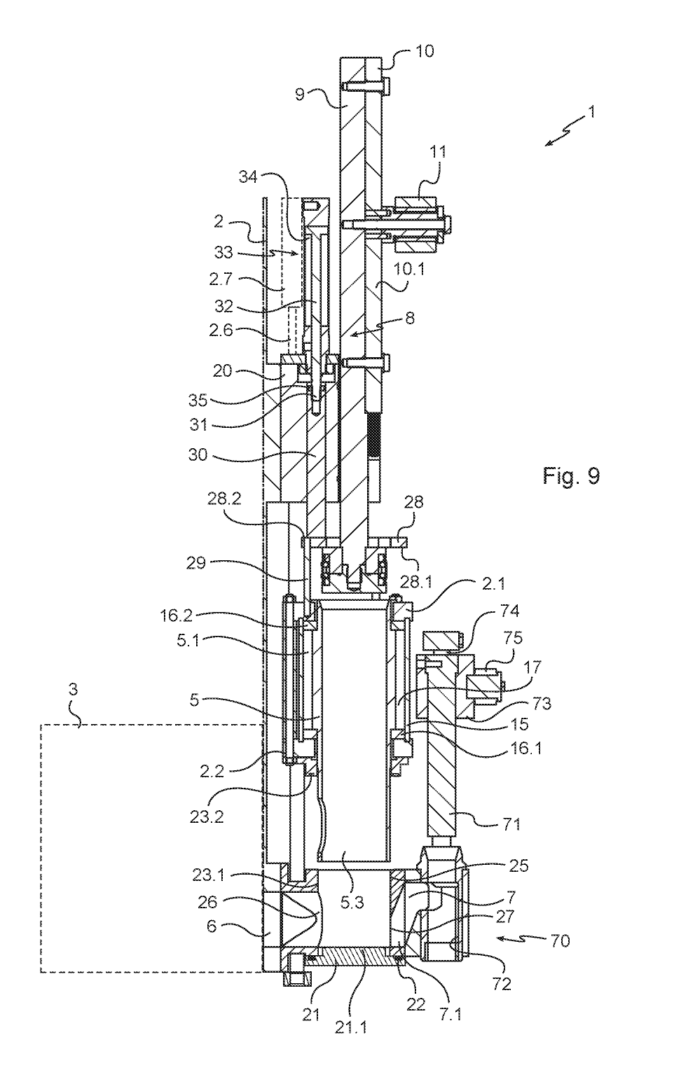

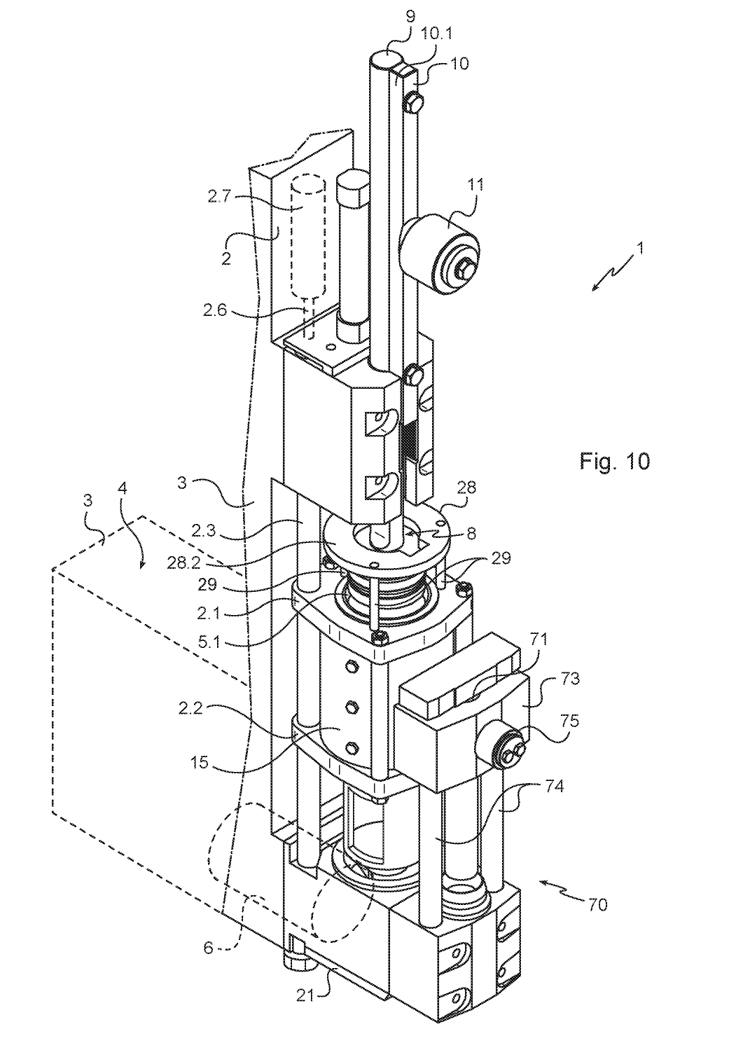

When it is necessary to clean the metering machine 1, for example on changing the product to be metered, the operations are as follows. In a first demounting step, the retraction of the piston rod 34 of the cylinder 32 is commanded. In a second demounting step, the guide rail commands the roller cam 11 to slide the piston 8 along the axis X from its working position in which it is inside the metering sleeve 5 to a cleaning position in which the piston 8 is disengaged from the metering sleeve 5. When it slides, the head of the piston 8 comes into contact with the lower face 28.1 of the abutment 28. This situation is represented in FIG. 8. In a second demounting step represented in FIG. 9 the guide rail commands the roller cam 11 to slide the piston 8 along the axis X. During this movement the piston 8 therefore drives the metering sleeve 5, which slides out of the plug 23 and is then disengaged from the latter and in a cleaning position. The radial window 12 is therefore disengaged from the outlet 6 of the hopper 3 and the metering siphon 7. This situation is represented in FIGS. 9 and 10.

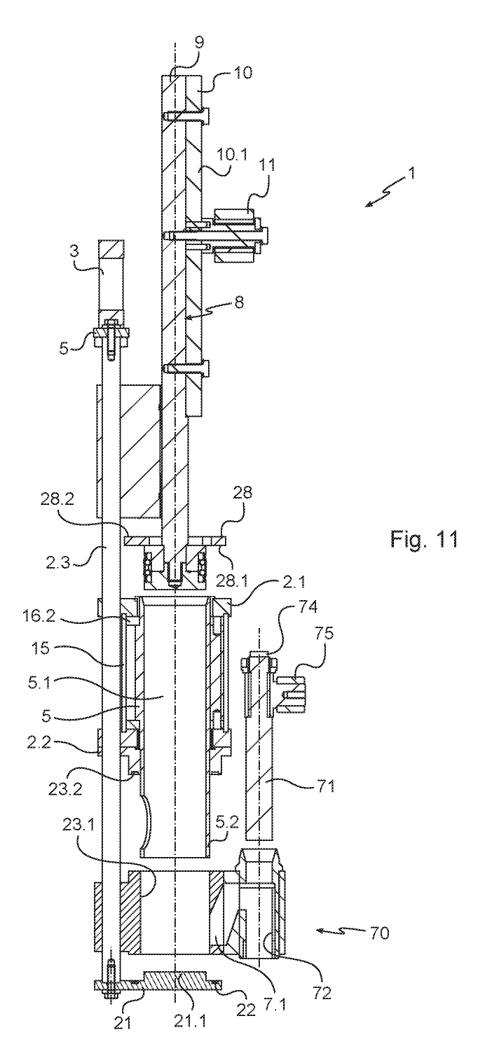

In a third demounting step the deployment of the piston rod 2.6 of the cylinder 2.7 is commanded, which drives the columns 2.3 and 2.4 in translation and causes the disk 21 to be moved away from the lower portion of the plug 23. This situation is represented in FIG. 11.

It is then a simple matter to rinse clean all of the installation in that all the volumes receiving the product to be metered (here the food paste 4) are accessible. For example, a cleaning liquid could be poured into the upper end 5.1 of the metering sleeve 5 and evacuated from the lower end 5.3. A similar procedure could be adopted for cleaning the plug 23 by introducing a cleaning liquid into the hopper 3 or via its upper end. As can be seen in FIGS. 9, 10 and 11, the cam controlling the roller 75 can simultaneously command movement in translation of the plunger 71 along an axis parallel to the axis X to disengage the plunger 71 from the discharge pipe 72 and to enable the metering siphon 7 to be cleaned. All parts of the metering machine 1 in contact with the product to be metered are easily accessible and can even be brushed.

When the cleaning operations have finished, the cams respectively command, via the rollers 11 and 75, the sliding of the piston 8 and of the plunger 71 to their respective low points. During this movement, the metering sleeve 5 is engaged in the plug 23 until the seal 23.2 of the flange 2.2 comes to bear on the upper portion of the plug 23. The piston 8 is then engaged in the metering sleeve 5 and continues to slide as far as the position represented in FIG. 2. During this movement, the plunger 71 is engaged in the discharge pipe 72. When the piston 8 hand the plunger 71 are in place, the deployment of the piston 32 of the cylinder 33 is commanded so that the rod 30 comes into contact with the upper face 28.2 of the abutment 28. The position of the counter-nut 35 on the piston 32 is adjusted so that the force applied is sufficient to block movement in translation of the metering sleeve 5. Finally, retraction of the piston rod 2.6 of the cylinder 2.7 is commanded to return the disk 21 and its seal 22 into contact with the lower portion of the plug 23. The feed pressure of the cylinder 2.7 makes it possible to control the force compressing the seal 22.

According to a preferred embodiment not shown, the means for driving rotation of the metering sleeve comprise a sector gear, here covering an angular amplitude of 100°, secured to the metering sleeve. The means for driving rotation of the metering sleeve also comprise a rotary actuator, here a pneumatic rotary jack, carrying a pinion cooperating with the sector gear. The radial windows of the plug are disposed at 100 degrees from one another and a rotation of the pneumatic rotary actuator positions the window of the piston in front of one or the other of the windows of the plug.

Of course, the invention is not limited to the embodiment described and encompasses any variant within the field of the invention as defined by the claims.

In particular,
although here a metering siphon is disposed between the metering sleeve and the discharge pipe, the invention applies equally to a metering machine with no metering siphon in which the radial window of the metering sleeve directly faces the discharge pipe;
although here the product to be packaged is a food paste, the invention applies equally to other types of products such as for example liquid, viscous, liquid/solid composite products, foodstuffs or otherwise;
although here the metering machine has been described with reference to a single metering unit, the invention applies equally to a metering machine including a plurality of metering units mounted on a turntable moving relative to a cam in the form of a fixed rail cooperating with the rollers, for example;
although here the movements of the piston to disengage it from the metering sleeve and to disengage the metering sleeve from the plug are commanded by rollers engaged in guide rails, the invention applies equally to other types of motorized means such as for example pneumatic, hydraulic or electric actuators, either linear or rotary;
although here the radial windows of the plug are disposed at 180° to each other, the invention applies equally to other types of distributions of these windows such as for example windows that are adjacent or separated by an angle greater than or less than 120°; the same applies to the bars 18 and 19;
although here the radial window of the plug opening onto the outlet of the feed hopper has a diameter greater than that opening onto the metering siphon, the invention applies equally to radial windows having identical diameters or in which the ratio between the diameters is different;
although here the means driving rotation of the metering sleeve include a tube portion defining a chamber extending around the metering sleeve, the invention applies equally to a chamber extending partly around the sleeve;
although here a wall delimits two sealed volumes in the chamber extending around the metering sleeve, the invention applies equally to a chamber in which a single sealed volume is delimited, possibly provided with position return means;
although here the means driving rotation of the metering sleeve include a chamber divided into two sealed volumes, the invention applies equally to other types of means for driving rotation of the metering sleeve, such as for example a toothed ring connected to a motor, a linear actuator tangential to the sleeve, electromagnetic masses acting on a ferromagnetic nipple fastened to the metering sleeve or one or more windings;
although here the injection of air into the nozzles is controlled by a cam system, the invention applies equally to other types of controller such as for example a logic processing unit or a microcontroller controlling solenoid valves;
although here the control fluid of the actuators and sealed volumes is compressed air, the invention applies equally to other types of control such as for example hydraulic or electrical control;
although here the abutment is of annular shape, the invention applies equally to other abutment shapes and other types of actuators for blocking movement in translation of the metering sleeve such as for example means for gripping the sleeve, one or more fingers engaged in a groove or a bore in the metering sleeve;
although here the actuator for blocking movement in translation of the metering sleeve includes a counter-nut that is screwed onto the end of its piston and makes it possible to adjust the immobilizing force exerted on the metering sleeve, the invention applies equally to other means for adjusting the force for blocking movement in translation of the metering sleeve such as for example a proportional distributor or an end provided with compressible elastic means;
although here, in order to facilitate its description, the steps of the metering and demounting-remounting operations have been described as successive, the invention applies equally to simultaneous execution of some steps;
although here the demounting operations have been described from a position of the metering sleeve in which the radial window of the metering sleeve faces the outlet of the feed hopper, the invention applies to cleaning operations carried out with the metering sleeve in any position relative to the plug.

1. A metering machine including a frame on which are mounted a feed hopper and a metering sleeve mounted between an outlet of the feed hopper and a discharge pipe, the metering sleeve receives slidably along a longitudinal axis a suction and discharge piston, the metering machine including means for driving the suction and discharge piston and being characterized in that the metering sleeve includes a radial window and is rotatable about the longitudinal axis by rotation drive means to position the metering sleeve selectively in a first position in which the radial window faces the outlet of the feed hopper and a second position in which the radial window faces a feed end of the discharge pipe.

2. The machine according to claim 1, wherein the suction and discharge piston is mounted on the frame to slide between a working first position in which the suction and discharge piston is in the metering sleeve and a cleaning position in which the suction and discharge piston is disengaged from the metering sleeve.

3. The machine according to claim 2, wherein the metering sleeve includes an abutment disposed so that the suction and discharge piston comes into contact therewith when it goes to the cleaning position.

4. The machine according to claim 1, wherein the metering sleeve is slidably mounted on the frame to move between a working axial position in which the radial window can be pivoted between its first and second positions and a cleaning axial position in which the radial window is disengaged from the outlet of the feed hopper and the discharge pipe.

5. The machine according to claim 1, wherein a lower end of the metering sleeve is rotatably engaged in a plug including a first orifice connected to the outlet of the feed hopper and a second orifice connected to the discharge pipe.

6. The machine according to claim 2, wherein the machine includes motorized means for disengaging the suction and discharge piston from the metering sleeve and the metering sleeve from the plug.

7. The machine according to claim 1, in which the means for driving rotation of the metering sleeve include a wall projecting from the metering sleeve that delimits at least one sealed volume in a chamber fastened to the frame, the chamber extending at least partly around the metering sleeve and having at one or both of its ends a fluid feed end so that introduction of fluid into the sealed volume causes the metering sleeve to rotate from the first position of the metering sleeve to the second position of the metering sleeve.

8. The machine according to claim 7, wherein the wall delimits two sealed volumes each having a fluid feed end.

9. The machine according to claim 1, including an actuator fastened to the frame selectively to block movement in translation of the metering sleeve along its longitudinal axis.

10. The machine according to claim 9, wherein the actuator is a cylinder the piston rod of which includes means for adjusting a force blocking movement in translation of the metering sleeve along its longitudinal axis.

11. The machine according to claim 1, wherein the means for driving the suction and discharge piston include a roller cam engaged in a guide rail.

12. The machine according to claim 1, wherein a metering siphon is disposed between the metering sleeve and the discharge pipe.

13. The machine according to claim 5, wherein the machine includes motorized means for disengaging the suction and discharge piston from the metering sleeve and the metering sleeve from the plug.
